(19) United States
(12) Patent Application Publication
(10) Pub. No.: US 2026/0228427 A1
(43) Pub. Date: Aug. 6, 2026

(54) DOCUMENT-RELATED QUERY ANSWERING USING A LANGUAGE GENERATION MODEL

(71) Applicant: ADOBE INC., SAN JOSE, CA (US)

(72) Inventors: Ruiyi Zhang, Mountain View, CA (US); Yufan Zhou, Santa Clara, CA (US); Tong Yu, Fremont, CA (US); Franck Dernoncourt, Seattle, WA (US); Jiuxiang Gu, Redmond, VA (US); Ryan A. Rossi, San Jose, CA (US); Jian Chen, Buffalo, NY (US); Tong Sun, San Ramon, CA (US)

(21) Appl. No.: 19/046,941

(22) Filed: Feb. 6, 2025

(51) Int. Cl. G06F 40/20; G06F 16/383

(52) U.S. Cl. CPC G06F 40/20; G06F 16/383

(57) ABSTRACT

A method, apparatus, non-transitory computer readable medium, and system for data processing includes receiving a document and a query requesting information about the document, identifying, using a language generation model, a relevant page of the document based on the query, and generating, using the language generation model, a response to the query based on the relevant page, wherein the response incudes the requested information about the document.

### BACKGROUND

The following relates generally to data processing, and more specifically to document-related query answering using a language generation model. Document related query answering refers to a process of providing a response to a query requesting information about a document (e.g., a file that may include one or more types of media, such as text, tables, charts, and images, presented using layouts of varying complexities). Language generation models, such as large language models, are machine learning models that are trained to predict a text output in response to an input prompt.

An existing approach to document-related query answering includes obtaining content and layout information for a document by parsing the document using techniques such as optical character recognition and layout parsing, constructing a prompt for a language model based on the content and layout information, and generating an output based on the prompt using the language model. Another existing approach includes attempting to manipulate a context window of a large language model, while providing each page of a document and a query as an input to a multi-modal machine learning model including the large language model to generate a response to the query. However, both document parsing and a direct input of a query and each page of a document to a multi-modal machine learning model is inefficient and time-consuming, especially for documents that include many pages.

### SUMMARY

Systems and methods are described for generating a response to a query requesting information about a document based on an identification of a page of the document that is particularly relevant to the query. In some embodiments, the data processing system first retrieves the relevant page of the document using a language generation model and uses the language generation model to generate the response based on the retrieved evidence pages.

The language generation model provides effective page representations for question-based retrieval, allowing the data processing system to efficiently determine a minimal portion of the document that is relevant to the query, and therefore to efficiently generate an accurate response to the query using a minimal amount of input information.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for answering a query according to aspects of the present disclosure.

FIG. 3 shows an example of a data processing system for generating a response to a query according to aspects of the present disclosure.

FIG. 4 shows an example of a data processing system for identifying a relevant page of a document according to aspects of the present disclosure.

FIG. 5 shows an example of a data processing system for generating a response to a query according to aspects of the present disclosure.

FIG. 6 shows an example of a transformer according to aspects of the present disclosure.

FIG. 7 shows an example of a method for generating a response to a query according to aspects of the present disclosure.

FIG. 8 shows an example of a method for computing a similarity score according to aspects of the present disclosure.

FIG. 9 shows an example of a method for generating a response to a query based on an inter-sequence similarity metric according to aspects of the present disclosure.

FIG. 10 shows an example of an algorithm for training a machine learning model according to aspects of the present disclosure.

FIG. 11 shows an example of a flow diagram depicting an algorithm as a step-by-step procedure for training a machine-learning model according to aspects of the present disclosure according to aspects of the present disclosure.

FIG. 12 shows an example of a computing device according to aspects of the present disclosure.

FIG. 13 shows an example of a data processing apparatus according to aspects of the present disclosure.

### DETAILED DESCRIPTION

The following relates generally to data processing, and more specifically to document-related query answering using a language generation model. Document related query answering refers to a process of providing a response to a query requesting information about a document (e.g., a file that may include one or more types of media, such as text, tables, charts, and images, presented using layouts of varying complexities). Language generation models, such as large language models (LLMs), are machine learning models that are trained to predict a text output in response to an input prompt.

An existing approach to document-related query answering includes obtaining content and layout information for a document by parsing the document using techniques such as optical character recognition and layout parsing, constructing a prompt for a language model based on the content and layout information, and generating an output based on the prompt using the language model. Another existing approach includes attempting to manipulate a context window of a large language model, while providing each page of a document and a query as an input to a multi-modal machine learning model including the large language model to generate a response to the query. However, both document parsing and a direct input of a query and each page of a document to a multi-modal machine learning model is inefficient and time-consuming, especially for documents that include many pages.

Accordingly, systems and methods are described for generating a response to a query requesting information about a document based on an identification of a page of the document that is particularly relevant to the query. In some embodiments, the data processing system first retrieves the relevant page of the document using a language generation model and uses the language generation model to generate the response based on the retrieved evidence pages.

For example, in some embodiments, the data processing system generates a visual embedding of a page of the document. The data processing system uses the language generation model to generate respective embeddings of the query and the visual embedding, and compares the respective embeddings with each other to determine whether the page of the document is relevant to the query. This approach allows for generalization across document types, as the embedding of the visual embedding provides an effective page representation for question-based retrieval. Furthermore, identifying the relevant page based on the embedding comparison is more efficient and accurate than using a classical document parser to extract information from the document to formulate a prompt for an LLM, as it is difficult to recover a document layout in prompts, and a document parser suffers from performance degradation.

Additionally, identifying the relevant page using the embedding comparison is more efficient than techniques which attempt to exploit long context windows of LLMs, as most of the pages of a document may not be relevant to the query, and an efficiency of the LLM is compromised when the document includes many (e.g., hundreds) of pages, or if there is a document collection.

Embodiments of the present disclosure may therefore provide accurate answers to questions even over long documents, or document collections, that include many (e.g., hundreds) of pages. According to some aspects, the document representation ability of the data processing system is further increased with contrastive training using one or more adaptation layers that are trained to increase a performance of the language generation model on specific domains. The one or more adaptation layers allow a same language generation model to perform both a page retrieval training task and a question answering training task while avoiding the expense of training each of the parameters of the language generation model to perform the two training tasks.

### Terminology Examples

A “document” comprises any item of media that includes one or more of text, an image, a chart, a table, or a graph. Examples of documents include word processing documents, text documents, portable document format (PDF) files, presentation slides, spreadsheets, image files, HTML files, website representations, etc. A “query” and a “response” each comprise a text string.

A “page” refers to a discrete portion of a document identified by the document itself, or by a software application used for viewing or processing the document, as being a page. A “relevant page” comprises a page of a document determined to be relevant to a query. In some embodiments, a page is determined to be relevant according to a similarity score determined based on an embedding corresponding to the page and an embedding corresponding to the query. A “similarity score” is a numerical measure of a similarity between two objects.

An “embedding” refers to a representation of an object in a lower-dimensional space such that semantic information about the object is more easily captured and analyzed by a machine learning model. In an example, an embedding is a numerical representation of the object in a continuous vector space (an embedding space) in which objects that include similar semantic information to each other correspond to vectors that are numerically similar to and thus “closer” to each other, thereby allowing a similarity between different objects corresponding to different embeddings to be readily determined (e.g., via a computation of a similarity score). An “embedding space” (or a “vector space”) refers to a set having embeddings (or vectors) as elements, and is characterized by a dimension specifying a number of independent directions in the embedding space.

In some embodiments, a “query embedding” refers to intermediate hidden states of a language generation model in response to an input corresponding to a query to the language generation model. In some embodiments, a “page embedding” refers to intermediate hidden states of the language generation model in response to an input corresponding to a document page to the language generation model. In some embodiments, a “low-dimensional feature space” refers to a feature space having a reduced number of dimensions than a previous feature space, such as a feature space corresponding to a hidden state of the language generation model.

An example of the data processing system is used in a question answering context. In the example, a user provides a multi-page presentation slide file (e.g., a document) to the data processing system, along with a query, the text string “What follows content creation in the flow chart?” The data processing system generates a query embedding based on the query and a page embedding based on each page of the document using a language generation model. The data processing system compares each page embedding to the query embedding and determines that a page embedding for a page depicting a flowchart including a step labeled “CONTENT CREATION” followed by a step labeled “RELATIONSHIP BUILDING & PM” is most similar to the query embedding.

The data processing system therefore determines that the page including the flowchart is a relevant page. The data processing system generates a prompt based on the relevant page and the query and provides the prompt as an input to the language generation model. The response, the text string “RELATIONSHIP BUILDING & PM”, includes information that is accurately responsive to the query. Accordingly, the data processing system is able to provide an accurate answer to a question about a visually complex document (e.g., a document including a flowchart with logical dependencies indicated by arrow directions of the flowchart) without having to directly parse the document to obtain information that attempts to describe the visual complexity.

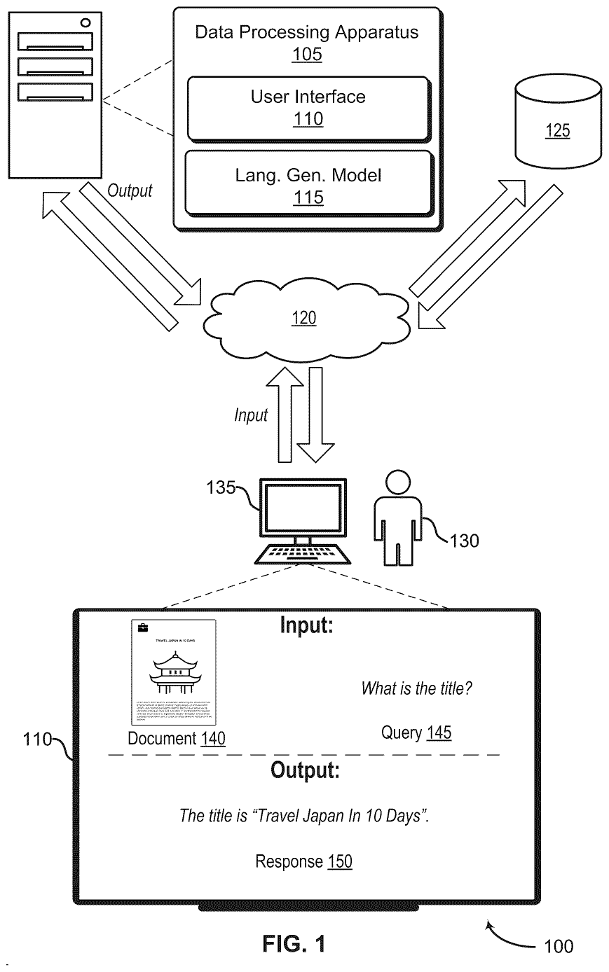

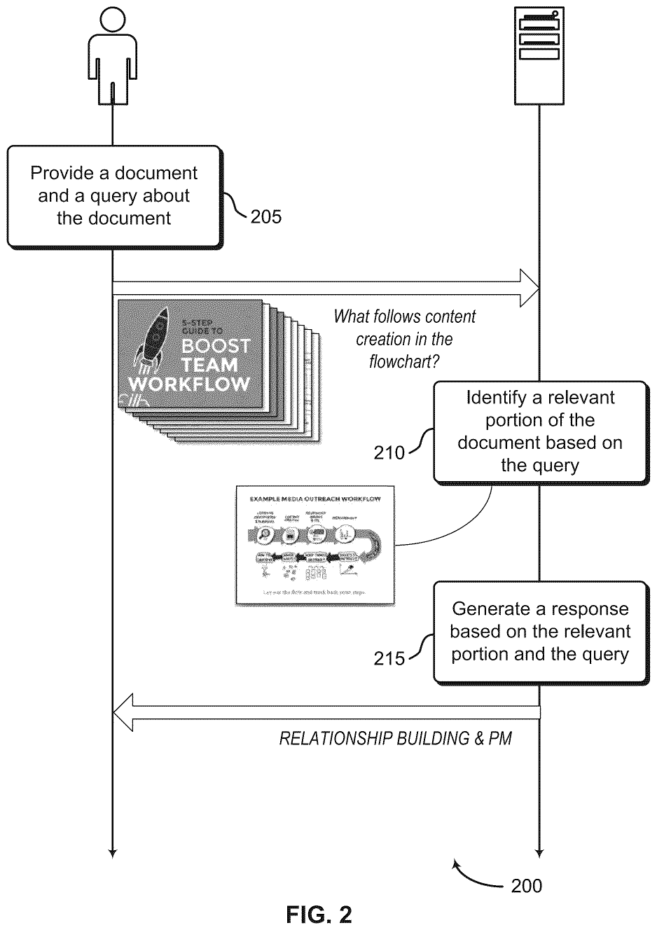

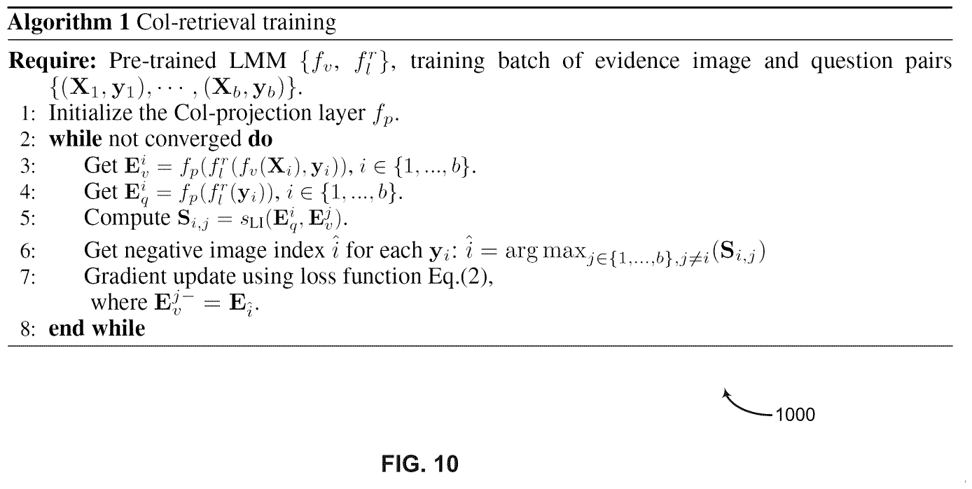

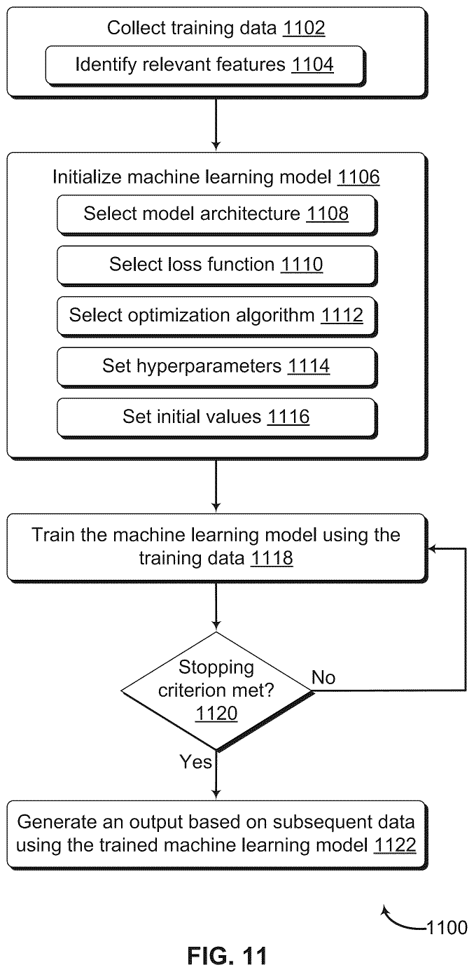

Further example applications of the present disclosure are provided with reference to FIGS. 1-2. Details regarding the architecture of the data processing system are provided with reference to FIGS. 1, 3-6, and 12-13. Details regarding a process for generating a response to a query are provided with reference to FIGS. 2 and 7-9. Details regarding a process for training a machine learning model are provided with reference to FIGS. 10-11.

### Data Processing System

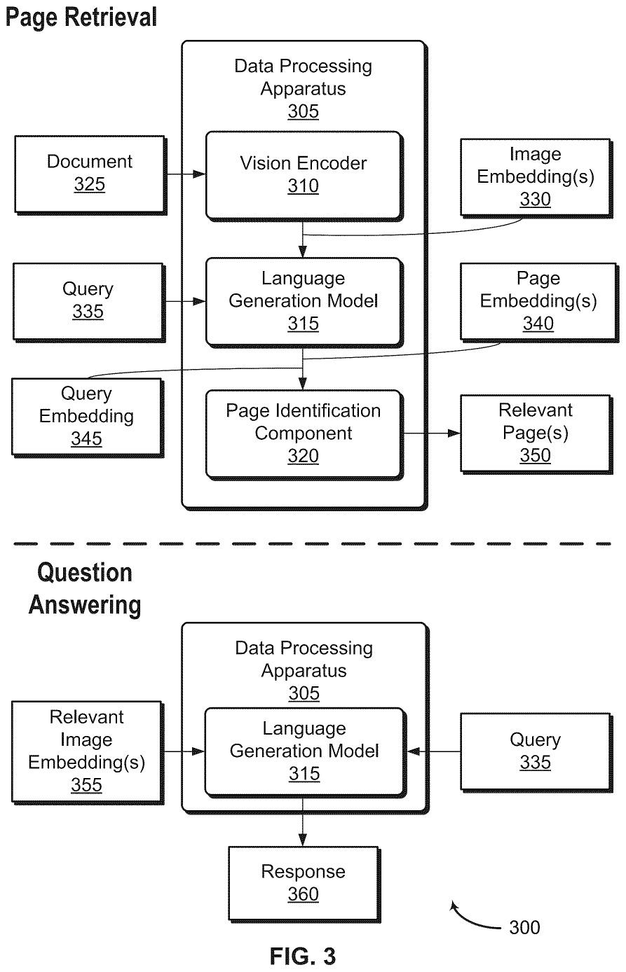

FIG. 1 shows an example of a data processing system 100 according to aspects of the present disclosure. The example shown includes data processing system 100, user 130, user device 135, document 140, query 145, and response 150. Data processing system 100 is an example of, or includes aspects of, the corresponding element described with reference to FIGS. 3-5. In one aspect, data processing system 100 includes data processing apparatus 105, cloud 120, and database 125. In one aspect, data processing apparatus 105 includes user interface 110 and language generation model 115.

Referring to FIG. 1, according to some aspects, user interface 110 of data processing apparatus 105 receives a document (e.g., document 140) and a query (e.g., query 145, “What is the title?”) requesting information about the document from a user (e.g., user 130) via a user device (e.g., user device 135). User interface 110 may be displayed on the user device by data processing apparatus 105.

Data processing apparatus 105 identifies, using language generation model 115, a relevant page of the document based on the query. For example, in some embodiments, data processing apparatus 105 generates embeddings for each page of the document and an embedding for the query using language generation model 115, and compares the embeddings for the pages of the document with the embedding for the query to determine a set of similarity scores. Data processing apparatus 105 identifies a page or pages of the document that are most relevant to the query according to the similarity scores corresponding to the page or pages. Language generation model 115 then generates a response to the query (e.g., response 150, “The title is ‘Travel Japan In 10 Days’.”) based on the query and the relevant page(s). The response includes the requested information about the document. The response may be based on the image.

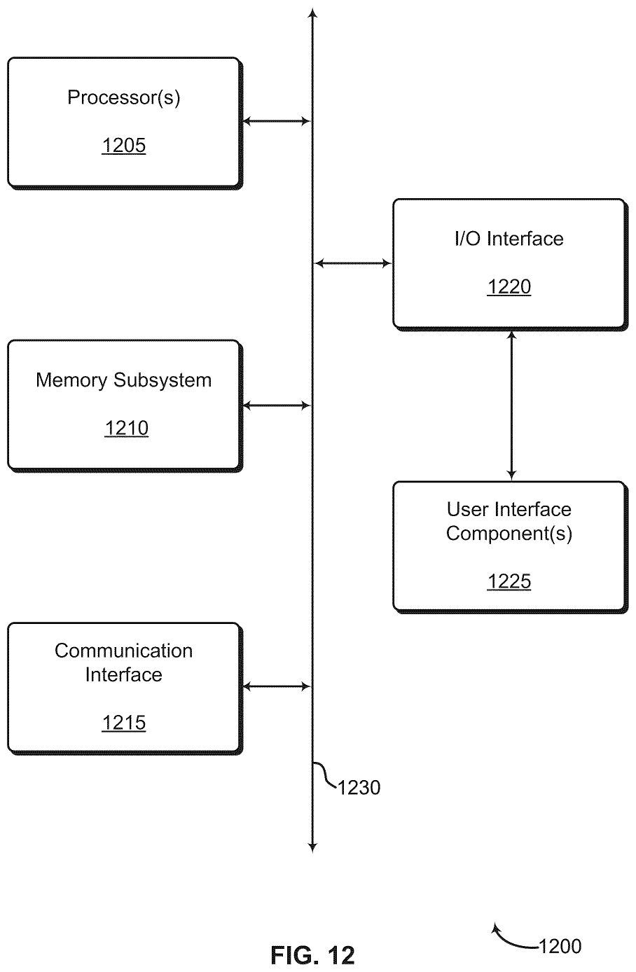

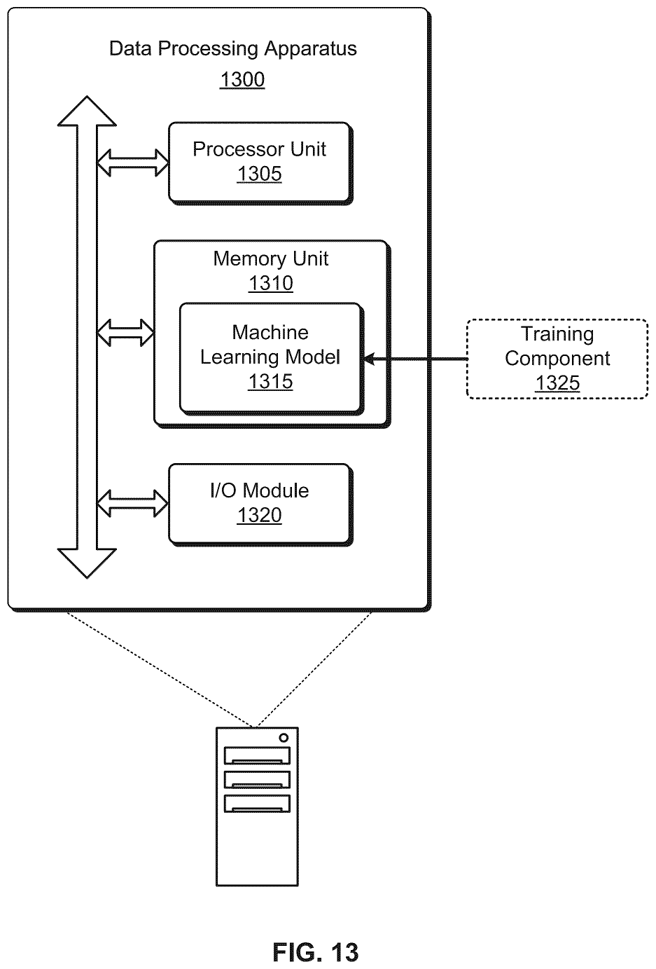

According to some aspects, data processing apparatus 105 includes a computer-implemented network. In some embodiments, the computer-implemented network includes a machine learning model (such as the machine learning model 1315 described with reference to FIG. 13, e.g., language generation model 115). Data processing apparatus 105 may also include one or more processors, a memory subsystem, a communication interface, an I/O interface, one or more user interface components, and a bus as described with reference to FIG. 12. Additionally, data processing apparatus 105 may communicate with user device 135 and database 125 via cloud 120. According to some aspects, user interface 110 comprises a text interface, a graphical user interface, or a combination thereof.

According to some aspects, data processing apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

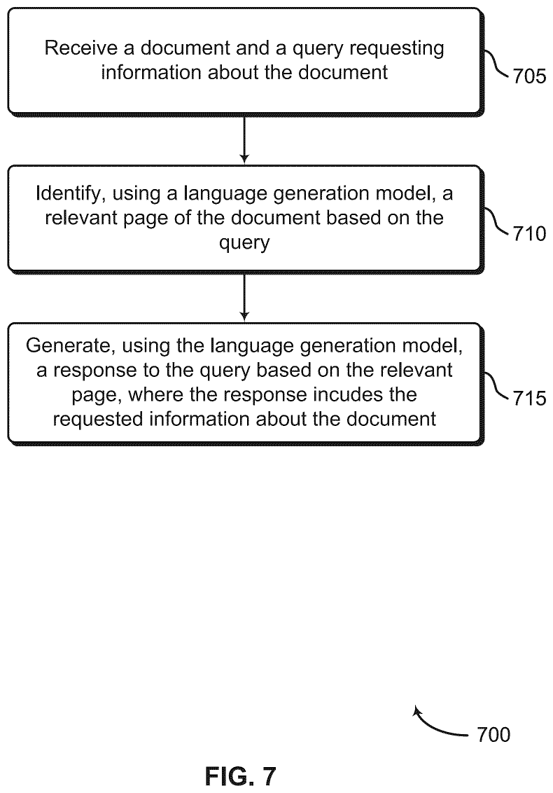

Further detail regarding the architecture of a data processing system is provided with reference to FIGS. 3-6 and 12-13. Further detail regarding a process for generating a response to a query is provided with reference to FIGS. 7-9. Further detail regarding a process for training a machine learning model is provided with reference to FIGS. 10-11.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between data processing apparatus 105, database 125, and user device 135.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in data processing apparatus 105. According to some aspects, database 125 is external to data processing apparatus 105 and communicates with data processing apparatus 105 via cloud 120.

According to some aspects, user device 135 is a personal computer, laptop computer, mainframe computer, palmtop computer, personal assistant, mobile device, or any other suitable processing apparatus. User device 135 may include software that displays user interface 110 provided by data processing apparatus 105. The user interface 110 allows information to be communicated between user 130 and data processing apparatus 105.

According to some aspects, a user device user interface enables a user to interact with user device 135. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

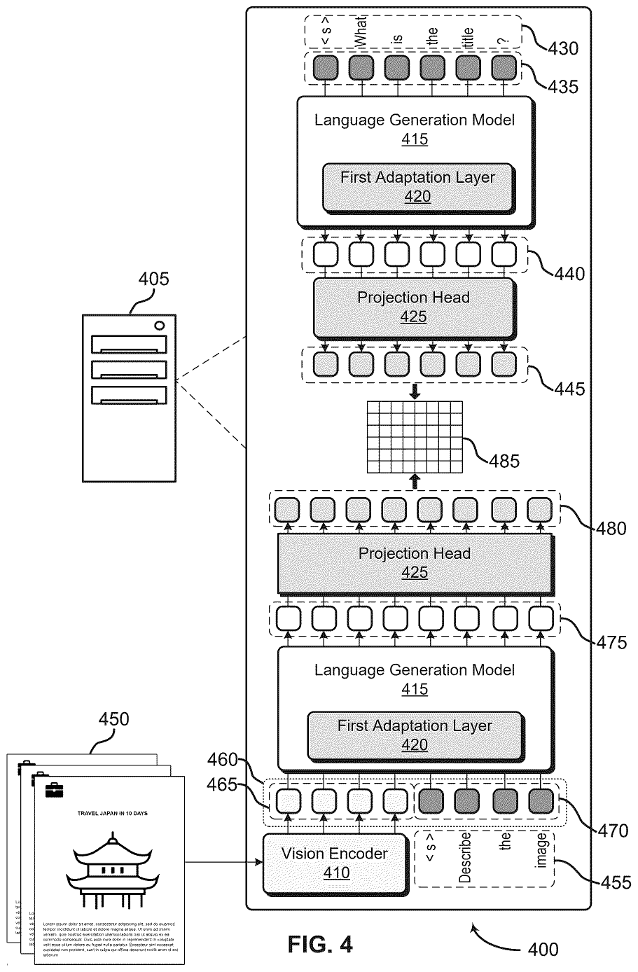

Data processing apparatus 105 is an example of, or includes aspects of, the corresponding element described with reference to FIGS. 3-5 and 12-13. Language generation model 115 is an example of, or includes aspects of, the corresponding element described with reference to FIGS. 3-5. Document 140 is an example of, or includes aspects of, the corresponding element described with reference to FIGS. 3 and 4. Query 145 is an example of, or includes aspects of, the corresponding element described with reference to FIGS. 3-5. Response 150 is an example of, or includes aspects of, the corresponding element described with reference to FIG. 3.

FIG. 2 shows an example of a method 200 for answering a query according to aspects of the present disclosure. Referring to FIG. 2, according to some aspects, a data processing system (such as the data processing system 100 described with reference to FIG. 1) performs method 200 to generate a response to a query that requests information about a document.

At operation 205, a user provides a document and a query about the document to the data processing system. In some cases, the operations of this step may be performed by a user as described with reference to FIG. 1. In the example of FIG. 2, the user provides a multi-page document and a query requesting information about the document, e.g., “What follows content creation in the flowchart?”

At operation 210, the data processing system identifies a relevant portion of the document based on the query. In some cases, the operations of this step refer to, or may be performed by, a data processing apparatus as described with reference to FIGS. 1, 3-5, and 12-13. In an example, the data processing system generates a page embedding for each page of the document and a query embedding for the query using a large language model (such as the language generation model 115 described with reference to FIG. 1). The data processing system determines one or more pages that are relevant to the query by determining which page embeddings are most similar to the query embedding. In the example of FIG. 2, the data processing system determines that a most relevant page of the document to the query is a page depicting a flowchart including a step labeled “CONTENT CREATION”.

At operation 215, the system generates a response based on the relevant portion and the query. In some cases, the operations of this step refer to, or may be performed by, a data processing apparatus as described with reference to FIGS. 1, 3-5, and 12-13. In an example, the data processing apparatus generates a response to the query based on the query and the relevant page using the language generation model. In the example of FIG. 2, the response includes the text string “RELATIONSHIP BUILDING & PM”, which is an accurate description of the step that follows “CONTENT CREATION” in the flowchart. Accordingly, the response includes the information requested in the query.

FIG. 3 shows an example of a data processing system 300 for generating a response to a query according to aspects of the present disclosure. The example shown includes data processing system 300, document 325, image embedding(s) 330, query 335, page embedding(s) 340, query embedding 345, relevant page(s) 350, relevant image embedding(s) 355, and response 360. In one aspect, data processing system 300 includes data processing apparatus 305. In one aspect, data processing apparatus 305 includes vision encoder 310, language generation model 315, and page identification component 320.

Multi-page document understanding aims to answer questions related to documents containing that may include both text and images. Referring to FIG. 3, according to some aspects, data processing system 300 performs a page retrieval process to identify relevant page(s) 350 of document 325 based on query 335 that requests information about document 325, and then generates response 360 based on relevant image embedding(s) 355 and query 335.

In an example, data processing apparatus 305 receives document 325 and generates a sequence of image embeddings 330(s), including one image embedding for each page of document 325, using vision encoder 310. Data processing apparatus 305 also receives query 335 requesting information about document 325. Data processing apparatus 305 provides image embedding(s) 330 as input to language generation model 315, and language generation model 315 generates page embedding(s) 340, including representations for each image embedding, in response.

Data processing apparatus 305 also provides query 335 as input to language generation model 315, and language generation model 315 generates query embedding 345 in response. Finally, page identification component 320 identifies relevant page(s) 350 of document 325 based on comparisons of query embedding 345 and page embedding(s) 340 (for example, via a computation of similarity scores between query embedding 345 and each of the page embedding(s) 340). The relevant page(s) 350 are therefore page(s) of document 325 that data processing apparatus 305 determines to be relevant for generating a response to query 335. A data processing apparatus for performing the page retrieval process is described in further detail with reference to FIG. 4.

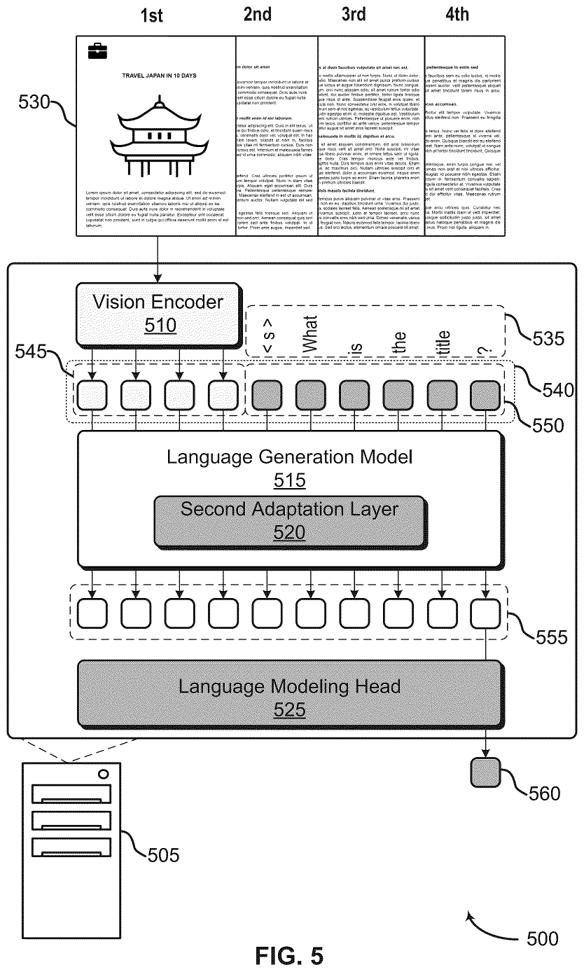

In the example, data processing apparatus 305 identifies relevant image embedding(s) 355 of relevant page(s) 350. In some cases, data processing apparatus 305 uses previously generated image embedding(s) 330 corresponding to relevant page(s) 350 as relevant image embedding(s) 355. In other cases, data processing apparatus generates relevant image embedding(s) 355 based on relevant page(s) 350 using vision encoder 310. Language generation model 315 generates response 360 based on an input of relevant image embedding(s) 355 and query 335. A data processing apparatus for performing the question answering process is described in further detail with reference to FIG. 5.

Data processing system 300 is an example of, or includes aspects of, the corresponding element described with reference to FIGS. 1 and 4-5. Data processing apparatus 305 is an example of, or includes aspects of, the corresponding element described with reference to FIGS. 1, 4-5, and 12-13. Vision encoder 310 is an example of, or includes aspects of, the corresponding element described with reference to FIGS. 4 and 5. Language generation model 315 is an example of, or includes aspects of, the corresponding element described with reference to FIGS. 1 and 4-5.

Document 325 is an example of, or includes aspects of, the corresponding element described with reference to FIGS. 1 and 4. Image embedding(s) 330 are an example of, or include aspects of, the corresponding element described with reference to FIGS. 4-5. Query 335 is an example of, or includes aspects of, the corresponding element described with reference to FIGS. 1, 4, and 5. Page embedding(s) 340 and query embedding 345 are examples of, or includes aspects of, the corresponding element described with reference to FIG. 4. Relevant page(s) 350 and relevant image embedding(s) are examples of, or include aspects of, the corresponding elements described with reference to FIG. 5. Response 360 is an example of, or includes aspects of, the corresponding element described with reference to FIG. 1.

FIG. 4 shows an example of a data processing system 400 for identifying a relevant page of a document according to aspects of the present disclosure. The example shown includes data processing system 400, query 430, query token embedding 435, query embedding 440, transformed query embedding 445, document 450, text prompt 455, retrieval prompt 460, page embedding 475, transformed page embedding 480, and similarity score matrix 485.

In one aspect, data processing system 400 includes data processing apparatus 405. In one aspect, data processing apparatus 405 includes vision encoder 410, language generation model 415, and projection head 425. In one aspect, language generation model 415 includes first adaptation layer 420. In one aspect, retrieval prompt 460 includes image embedding 465 and prompt token embedding 470.

In the example of FIG. 4, data processing apparatus 405 denotes a query q (e.g., query 430, “What is the tile?”) as a text token sequence {q₁, q₂, . . . , qᵢ}. In some embodiments, data processing apparatus 405 obtains the query token sequence using a prompt template. Data processing apparatus 405 generates a query token embedding y_{q} (e.g., query token embedding 435) based on the query text token sequence. In some cases, data processing apparatus 405 generates the query token embedding y_{q} using a text embedding model, such as Word2Vec or GloVe.

Word2Vec is a technique in natural language processing for obtaining vector representations of words. These vectors capture information about the meaning of the word based on the surrounding words. The Word2Vec algorithm estimates the representations by modeling text in a large corpus. Once trained, the model can detect synonymous words or suggest additional words for a partial sentence. GloVe, or Global Vectors for Word Representation, is a model for distributed word representation. The model is an unsupervised learning algorithm for obtaining vector representations for words. This is achieved by mapping words into a meaningful space where the distance between words is related to semantic similarity. Training is performed on aggregated global word-word co-occurrence statistics from a corpus, and the resulting representations showcase interesting linear substructures of the word vector space. As log-bilinear regression model for unsupervised learning of word representations, it combines the features of two model families, namely the global matrix factorization and local context window methods.

Data processing apparatus 405 uses language generation model 415 (e.g., a large language model

$$( LLM ) {f}_{l}^{r} )$$

to generate a query embedding

$${f}_{l}^{r} ( {y}_{q} )$$

(e.g., query embedding 440) based on the query token embedding y_{q}. In some embodiments, the query embedding

$${f}_{l}^{r} ( {y}_{q} )$$

comprises last hidden states of the

$$LLM {f}_{l}^{r} .$$

Projection head 425 (e.g., a projection layer fₚ) transforms the query embedding

$${f}_{l}^{r} ( {y}_{q} )$$

into a low-dimensional feature space to obtain a transformed query embedding

$${E}_{q} = {f}_{p} ( {f}_{l}^{r} ( {y}_{q} ) )$$

(e.g., transformed query embedding 445).

Furthermore, in the example of FIG. 4, data processing apparatus 405 denotes a document of n-pages (e.g., document 450) as a corresponding sequence of images, X={x₁, x₂, . . . , xₙ}. For an input image X of the sequence of images, a vision encoder fᵥ (e.g., vision encoder 410) computes a sequence of visual embeddings fᵥ(X) (e.g., image embedding 465). In some cases, data processing apparatus 405 tokenizes a predetermined text prompt (e.g., text prompt 455, “Describe the image”) as a text token sequence {v₁, v₂, . . . , vₘ} and generates a prompt token embedding yᵥ (e.g., prompt token embedding 470) based on the prompt text token sequence. In some cases, data processing apparatus 405 generates the prompt token embedding yᵥ using a text embedding model, such as Word2Vec or GloVe. Data processing apparatus 405 combines the sequence of visual embeddings fᵥ(X) and the prompt token embedding yᵥ (for example, by concatenation) to obtain a retrieval prompt fᵥ(X), yᵥ (e.g., retrieval prompt 460).

Data processing apparatus 405 uses the

$$LLM {f}_{l}^{r}$$

to generate a page embedding

$${f}_{l}^{r} ( {f}_{v} ( X ) , {y}_{v} )$$

(e.g., page embedding 475) based on the retrieval prompt fᵥ(X), yᵥ. In some embodiments, the page embedding

$${f}_{l}^{r} ( {f}_{v} ( X ) , {y}_{v} )$$

comprises last midden states of the

$$LLM {f}_{l}^{r} .$$

Projection layer fₚ transforms the page embedding

$${f}_{l}^{r} ( {f}_{v} ( X ) , {y}_{v} )$$

into the low-dimensional feature space to obtain a transformed page embedding Eᵥ=fₚ(fₗ^{r}(fᵥ(X),yᵥ)) (e.g., transformed page embedding 480), i.e., feature sequences. In some embodiments, data processing apparatus 405 likewise generates a page embedding.

$${f}_{l}^{r} ( {f}_{v} ( X ) , {y}_{v} )$$

for each page of the document. In some embodiments, data processing apparatus 405 likewise generates a transformed page embedding Eᵥ for each page of the document.

Data processing apparatus 405 then uses a page identification component (such as the page identification component 320 described with reference to FIG. 3) to compute a similarity score between each page embedding (e.g., represented by the transformed page embeddings Eᵥ) and the query embedding (e.g., represented by the transformed query embedding E_{q}). The similarity score measures a relevance of the page corresponding to the page embedding to the query. For example, the similarity scores indicate how similar each page embedding is to the query embedding, and the page identification component therefore ranks the page embeddings in order of similarity to identify a ranked list of relevant pages of the document.

According to some aspects, the page identification component identifies one or more relevant pages of the document based on the corresponding similarity scores. In some embodiments, a page is determined to be relevant if the similarity score associated with the page exceeds a similarity score threshold. In some embodiments, a page associated with a page embedding that is determined to be most similar to the query embedding according to the similarity score is determined to be the relevant page. In some embodiments, the one or more relevant pages are ranked in order of similarity to the query.

In some embodiments, the page identification component computes the similarity score as a late-interaction score s_{L1}(E_{q}, Eᵥ), represented in FIG. 4 by similarity score matrix 485. The late-interaction score comprises an inter-sequence similarity metric that captures more fine-grained question-image relevance than traditional single-vector encoders, such as CLIP. A contextualized late-interaction score between a text feature sequence E_{q}={e_{q1}, e_{q2}, . . . , e_{qn}} of length n and a visual sequence Eᵥ={eᵥ₁, eᵥ₂, . . . , eᵥₘ} of length m may be computed as:

$${s}_{LI} ( {E}_{q} , {E}_{v} ) = {\sum }_{i = 1}^{n} {max}_{j ∈ \{ 1 , … , m \}} , {e}_{{q}_{i}} \cdot {e}_{{v}_{j}}^{T} \qquad ( 1 )$$

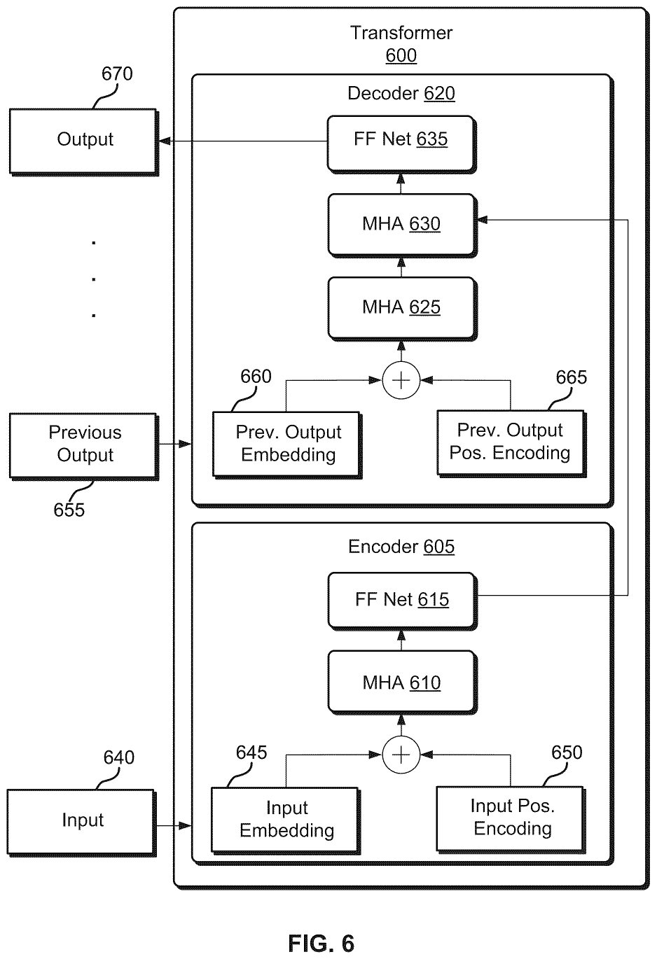

Vision encoder 410 comprises machine learning parameters stored in a memory unit of data processing apparatus 405, such as the memory unit 1310 described with reference to FIG. 13. According to some aspects, vision encoder 410 is configured to generate a visual embedding based on an image input, such as a convolutional neural network (CNN) or a vision transformer (ViT). A ViT decomposes an input image into a series of patches (rather than text into tokens), serializes each patch into a vector, and maps the vector to a smaller dimension with a single matrix multiplication. The vector embeddings are then processed by a transformer encoder as if they were token embeddings. An example of a transformer is described in further detail with reference to FIG. 6.

Language generation model 415 comprises machine learning parameters stored in a memory unit of data processing apparatus 405, such as the memory unit 1310 described with reference to FIG. 13. According to some aspects, language generation model 415 is configured to generate a text output based on an input, such as an LLM. LLMs acquire an ability to generate a text output by being trained upon a large amount of training data. In some embodiments, language generation model 415 comprises one or more transformers. An example of a transformer is described in further detail with reference to FIG. 6.

According to some aspects, language generation model 415 comprises first adaptation layer 420. First adaptation layer 420 comprises machine learning parameters trained to accommodate an image retrieval task. In some embodiments, the relevant page is identified using first adaptation layer 420. In some embodiments, first adaptation layer 420 is trained as described with reference to FIGS. 10-11.

In some embodiments, first adaptation layer 420 comprises a low-rank adaptation (LoRA) layer. According to some aspects, a LoRA layer is an artificial neural network (ANN) component that is designed to adapt weights of a pre-trained model to a new task or domain with reduced computational complexity and memory requirements. In transfer learning, a model trained on a source domain is fine-tuned on a target domain (e.g., a specific dataset related to a particular task) to leverage knowledge learned from the source domain. However, transferring the entire set of parameters from the pre-trained model may not be optimal due to differences in data distributions between the source and target domains, leading to suboptimal performance or overfitting.

A LoRA layer addresses this issue by decomposing the weight matrix of a neural network layer into low-rank matrices. The decomposition reduces the number of parameters in the LoRA layer, making the LoRA layer more adaptable to the target domain while preserving important features learned from the source domain. By reducing the rank of the weight matrix, the LoRA layer can capture the underlying structure of the data more efficiently.

Methods for LoRA include Singular Value Decomposition (SVD) and truncated SVD, which factorize the weight matrix into two or more low-rank matrices. These low-rank matrices are then used to initialize the weights of the adapted model.

By reducing the number of parameters in a model including the low-rank adaptation, the LoRA layer can speed up training and inference, thereby aiding task completion in resource-constrained environments. By adapting the model's parameters to the target domain while preserving important features from the source domain, low-rank adaptation can lead to more efficient generalization performance on the target task. Low-rank adaptation may act as a form of regularization, mitigating overfitting by imposing constraints on a parameter space of the model.

According to some aspects, projection head 425 comprises one or more feed-forward ANN layers, machine learning parameters of which are stored in a memory unit of data processing apparatus 405, such as the memory unit 1310 described with reference to FIG. 13. In some embodiments, projection head 425 is trained as described with reference to FIGS. 10-11. According to some aspects, vision encoder 410, language generation model 415, and projection head 425 comprise a retrieval component. In some embodiments, the retrieval component comprises a large multi-modal machine learning model (LMM).

Data processing system 400 is an example of, or includes aspects of, the corresponding element described with reference to FIGS. 1, 3, and 5. Data processing apparatus 405 is an example of, or includes aspects of, the corresponding element described with reference to FIGS. 1, 3, 5, and 12-13. Vision encoder 410 is an example of, or includes aspects of, the corresponding element described with reference to FIG. 5. Language generation model 415 is an example of, or includes aspects of, the corresponding element described with reference to FIGS. 1, 3, and 5.

Query 430 is an example of, or includes aspects of, the corresponding element described with reference to FIGS. 1, 3, and 5. Query token embedding 435 is an example of, or includes aspects of, the corresponding element described with reference to FIG. 4. Query embedding 440 and page embedding 475 are examples of, or include aspects of, the corresponding elements described with reference to FIG. 3. Document 450 is an example of, or includes aspects of, the corresponding element described with reference to FIGS. 1 and 3. Image embedding 465 is an example of, or includes aspects of, the corresponding element described with reference to FIG. 5.

FIG. 5 shows an example of a data processing system 500 for generating a response to a query according to aspects of the present disclosure. The example shown includes data processing system 500, relevant page 530, query 535, query prompt 540, query prompt embedding 555, and predicted token 560. In one aspect, query prompt 540 includes relevant image embedding 545 and query token embedding 550.

In one aspect, data processing system 500 includes data processing apparatus 505. In one aspect, data processing apparatus 505 includes vision encoder 510 and language generation model 515. In one aspect, language generation model 515 includes second adaptation layer 520 and language modeling head 525.

According to some aspects, data processing apparatus 505 identifies an image embedding (e.g., relevant image embedding 545) associated with each of one or more relevant pages of a document identified by a page identification component as described with reference to FIG. 3, respectively. In some embodiments, data processing apparatus 505 selects an image embedding corresponding to the relevant page as the relevant image embedding. In some embodiments, data processing apparatus 505 provides the one or more relevant pages to a vision encoder fᵥ (e.g., vision encoder 510), and the vision encoder fᵥ generates the one or more relevant image embeddings. In the example of FIG. 5, data processing apparatus 505 has identified one relevant page from among four pages of the document, which are shown in ranked order according to associated similarity score order. The relevant page includes a title of the document, and the page is therefore relevant to the query, “What is the title?”.

Data processing apparatus 505 combines (for example, by concatenating) the relevant image embedding with a query token embedding (e.g., query token embedding 550) generated based on a query (e.g., query 535) as described with reference to FIG. 4 to obtain a query prompt (e.g., query prompt 540). Data processing apparatus 505 provides the query prompt as input to language generation model 515 (e.g., an LLM fj). Language generation model 515 generates a query prompt embedding 555 (e.g., last hidden states of language generation model 515) based on the input, and a language modeling head of language generation model (e.g., language modeling head 525) predicts a next token (e.g., predicted token 560) for a response to the query based on query prompt embedding 555. The response comprises a text rendering of each token predicted by the language modeling head. The response includes the requested information about the document.

According to some aspects, language generation model 515 comprises second adaptation layer 520. In some embodiment, language generation model 515 generates the response using second adaptation layer 520. Second adaptation layer 520 is similar to the first adaptation layer 420 described with reference to FIG. 4. However, second adaptation layer 520 is trained separately from first adaptation layer 420 to accommodate a question answering task. Accordingly, in some embodiments, using both the first adaptation layer and the second adaptation layer allows a language generation model 415 to be efficiently optimized for both an image retrieval task and a question answering task while avoiding training the remaining layers of the language generation model and adding a minimal number of parameters to the language generation model. In some embodiments, second adaptation layer 520 is trained as described with reference to FIGS. 10-11.

Data processing system 500 is an example of, or includes aspects of, the corresponding element described with reference to FIGS. 1 and 3-4. Data processing apparatus 505 is an example of, or includes aspects of, the corresponding element described with reference to FIGS. 1, 3-4, and 12-13. Vision encoder 510 is an example of, or includes aspects of, the corresponding element described with reference to FIG. 4. Language generation model 515 is an example of, or includes aspects of, the corresponding element described with reference to FIGS. 1, 3, and 4.

Relevant page 530 is an example of, or includes aspects of, the corresponding element described with reference to FIG. 3. Query 535 is an example of, or includes aspects of, the corresponding element described with reference to FIGS. 1 and 3-4. Relevant image embedding 545 is an example of, or include aspects of, the corresponding element described with reference to FIGS. 3-4. Query token embedding 550 is an example of, or includes aspects of, the corresponding element described with reference to FIG. 4.

FIG. 6 shows an example of a transformer 600 according to aspects of the present disclosure. The example shown includes encoder 605, decoder 620, input 640, input embedding 645, input positional encoding 650, previous output 655, previous output embedding 660, previous output positional encoding 665, and output 670. According to some aspects, transformer 600 comprises architectural elements of the language generation model described with reference to FIGS. 1 and 3-5. According to some aspects, transformer 600 comprises architectural elements of the vision encoder described with reference to FIGS. 3-5.

According to some aspects, a transformer comprises one or more ANNs comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Encoder 605 includes multi-head self-attention sublayer 610 and feed-forward network sublayer 615. Decoder 620 includes first multi-head self-attention sublayer 625, second multi-head self-attention sublayer 630, and feed-forward network sublayer 635.

Encoder 605 is configured to map input 640 (for example, a prompt) to a sequence of continuous representations that are fed into decoder 620. Decoder 620 generates output 670 (e.g., a prediction of an output sequence of words or tokens) based on the output of encoder 605 and previous output 655 (e.g., a previously predicted output sequence), which allows for the use of autoregression.

For example, encoder 605 parses input 640 into tokens and vectorizes the parsed tokens to obtain input embedding 645, and adds input positional encoding 650 (e.g., positional encoding vectors for input 640 of a same dimension as input embedding 645) to input embedding 645. Input positional encoding 650 includes information about relative positions of words or tokens in input 640.

Encoder 605 comprises one or more encoding layers that generate contextualized token representations, where each representation corresponds to a token that combines information from other input tokens via self-attention mechanism. Each encoding layer of encoder 605 comprises a multi-head self-attention sublayer (e.g., multi-head self-attention sublayer 610). The multi-head self-attention sublayer implements a multi-head self-attention mechanism that receives different linearly projected versions of queries, keys, and values to produce outputs in parallel. Each encoding layer of encoder 605 also includes a fully connected feed-forward network sublayer (e.g., feed-forward network sublayer 615) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 2 )$$

Each layer employs different weight parameters (W₁, W₂) and different bias parameters (b₁, b₂) to apply a same linear transformation to each word or token in input 640.

Each sublayer of encoder 605 is followed by a normalization layer that normalizes a sum computed between a sublayer input x and an output sublayer(x) generated by the sublayer:

$$layernorm ( x + sublayer ( x ) ) \qquad ( 3 )$$

Encoder 605 is bidirectional because encoder 605 attends to each word or token in input 640 regardless of a position of the word or token in input 640.

Decoder 620 comprises one or more decoding layers (e.g., six decoding layers). Each decoding layer comprises three sublayers including a first multi-head self-attention sublayer (e.g., first multi-head self-attention sublayer 625), a second multi-head self-attention sublayer (e.g., second multi-head self-attention sublayer 630), and a feed-forward network sublayer (e.g., feed-forward network sublayer 635). Each sublayer of decoder 620 is followed by a normalization layer that normalizes a sum computed between a sublayer input x and an output sublayer(x) generated by the sublayer.

Decoder 620 generates previous output embedding 660 of previous output 655 and adds previous output positional encoding 665 (e.g., position information for words or tokens in previous output 655) to previous output embedding 660. Each first multi-head self-attention sublayer receives the combination of previous output embedding 660 and previous output positional encoding 665 and applies a multi-head self-attention mechanism to the combination. For each word in an input sequence, each first multi-head self-attention sublayer of decoder 620 attends only to words preceding the word in the sequence, and so a prediction of transformer 600 for a word at a particular position only depends on known outputs for a word that came before the word in the sequence. In some cases, each first multi-head self-attention sublayer implements multiple single-attention functions in parallel by introducing a mask over values produced by the scaled multiplication of matrices Q and K by suppressing matrix values that would otherwise correspond to disallowed connections.

Each second multi-head self-attention sublayer implements a multi-head self-attention mechanism similar to the multi-head self-attention mechanism implemented in each multi-head self-attention sublayer of encoder 605 by receiving a query Q from a previous sublayer of decoder 620 and a key K and a value V from the output of encoder 605, allowing decoder 620 to attend to each word in the input 640.

Each feed-forward network sublayer implements a fully connected feed-forward network similar to feed-forward network sublayer 615. The feed-forward network sublayers are followed by a linear transformation and a softmax to generate a prediction of output 670.

### Data Processing

FIG. 7 shows an example of a method 700 for generating a response to a query according to aspects of the present disclosure. Referring to FIG. 7, a data processing system (such as the data processing system 100 described with reference to FIG. 1) performs method 700 to generate a response to a query requesting information about a document, where the response includes the requested information. In some embodiments, the data processing system first retrieves evidence pages (or relevant pages) of the document using a language generation model to obtain relevant information from within a potentially vast and varied landscape of content, and uses the language generation model to generate the response based on the retrieved evidence pages.

According to some aspects, the data processing system uses a vision encoder to generate one or more image embeddings of the document and uses the language generation model to generate embeddings of the query and the image embeddings, which may be compared with each other to determine the evidence pages. Using the vision encoder and the language generation model as an information encoder allows for generalization across document types, as hidden states of machine learning models provide effective page representations for question-based retrieval. Furthermore, identifying evidence pages based on a comparison of embeddings of the pages and of the query is more efficient and accurate than using a classical document parser to extract information from the document to formulate a prompt for an LLM, as it is difficult to recover a document layout in prompts and a document parser suffers from performance degradation. Additionally, identifying the relevant pages using a comparison of embeddings is more efficient than techniques which attempt to exploit long context windows of LLMs, as most of the pages of a document may not be relevant to the query, and an efficiency of the LLM is compromised when the document includes many (e.g., hundreds) of pages, or if there is a document collection.

Embodiments of the present disclosure may therefore answer questions over long documents or document collections with many (e.g., hundreds) of pages. According to some aspects, the document representation ability of the data processing system is further increased with contrastive training using one or more adaptation layers that are trained to increase a performance of the language generation model on specific domains.

At operation 705, the system receives a document and a query requesting information about the document. In some cases, the operations of this step refer to, or may be performed by, a data processing apparatus as described with reference to FIGS. 1, 3-5, and 12-13. In an example, a user provides the document and the query to the data processing apparatus via a user interface displayed on a user device by the data processing apparatus as described with reference to FIG. 1.

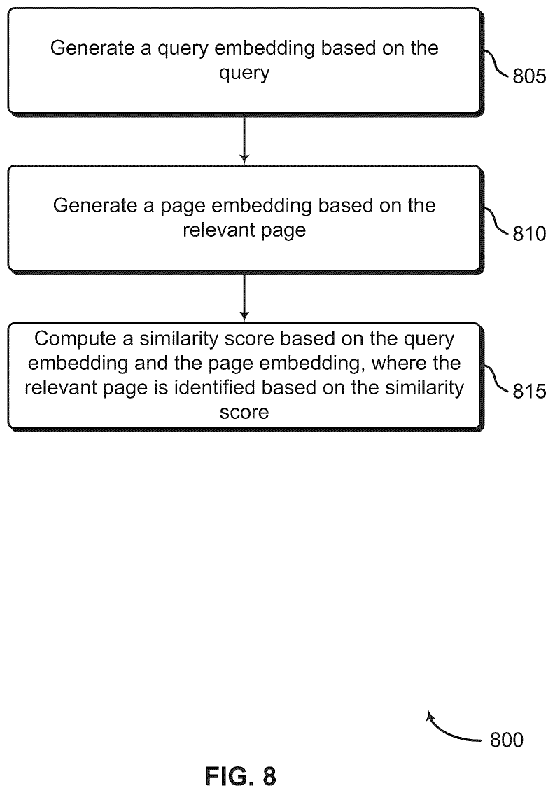

At operation 710, the system identifies, using a language generation model, a relevant page of the document based on the query. In some cases, the operations of this step refer to, or may be performed by, a data processing apparatus as described with reference to FIGS. 1, 3-5, and 12-13. In an example, the data processing apparatus generates a page embedding based on a page of the document using a language generation model, generates a query embedding based on the query using the language generation model, computes a similarity score based on the page embedding and the query embedding, and identifies the relevant page based on the similarity score as described with reference to FIGS. 3-4. In some embodiments, the data processing system computes the similarity score as described with reference to FIG. 8.

At operation 715, the system generates, using the language generation model, a response to the query based on the relevant page, where the response incudes the requested information about the document. In some cases, the operations of this step refer to, or may be performed by, a language generation model as described with reference to FIGS. 1 and 3-5. In an example, the language generation model generates the response as described with reference to FIGS. 3 and 5.

FIG. 8 shows an example of a method 800 for computing a similarity score according to aspects of the present disclosure. At operation 805, the system generates a query embedding based on the query. In some cases, the operations of this step refer to, or may be performed by, a language generation model as described with reference to FIGS. 1 and 3-5. In an example, the language generation model generates the query embedding as described with reference to FIGS. 3 and 4.

At operation 810, the system generates a page embedding based on the relevant page. In some cases, the operations of this step refer to, or may be performed by, a language generation model as described with reference to FIGS. 1 and 3-5. In an example, the language generation model generates the page embedding as described with reference to FIGS. 3 and 4.

At operation 815, the system computes a similarity score based on the query embedding and the page embedding, where the relevant page is identified based on the similarity score. In some cases, the operations of this step refer to, or may be performed by, a page identification component as described with reference to FIG. 3. In an example, the page identification component computes the similarity score as described with reference to FIGS. 3-4.

Accordingly, a method for data processing is described with reference to FIGS. 7-8. One or more aspects of the method include receiving a document and a query requesting information about the document; identifying, using a language generation model, a relevant page of the document based on the query; and generating, using the language generation model, a response to the query based on the relevant page, wherein the response incudes the requested information about the document. In some aspects, the relevant page includes an image and the response to the query is based on the image.

Some examples of the method further include generating a query embedding based on the query. Some examples further include generating a page embedding based on the relevant page. Some examples further include computing a similarity score based on the query embedding and the page embedding, wherein the relevant page is identified based on the similarity score.

Some examples of the method further include transforming the query embedding into a low-dimensional feature space to obtain a transformed query embedding. Some examples further include transforming the page embedding into the low-dimensional feature space to obtain a transformed page embedding, wherein the similarity score is computed based on the transformed query embedding and the transformed page embedding. In some aspects, the similarity score comprises an inter-sequence similarity metric.

Some examples of the method further include encoding the relevant page to obtain an image embedding, wherein the page embedding is based on the image embedding. Some examples of the method further include combining the image embedding with a text prompt to obtain a retrieval prompt, wherein the page embedding is based on the retrieval prompt.

Some examples of the method further include combining the image embedding with the query to obtain a query prompt, wherein the response is generated based on the query prompt. Some examples of the method, apparatus further include identifying a plurality of relevant pages of the document, wherein the response is based on the plurality of relevant pages. In some aspects, the language generation model comprises a first adaptation layer and a second adaptation layer trained separately from the first adaptation layer.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

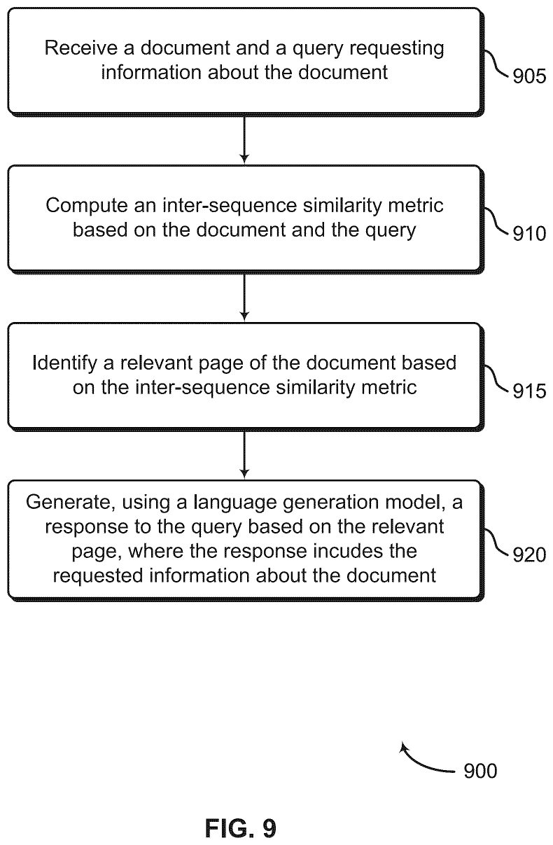

FIG. 9 shows an example of a method 900 for generating a response to a query based on an inter-sequence similarity metric according to aspects of the present disclosure. Referring to FIG. 9, a data processing system (such as the data processing system 100 described with reference to FIG. 1) performs method 900 to generate the response to the query, where the response includes information about a document requested by the query.

At operation 905, the system receives a document and a query requesting information about the document. In some cases, the operations of this step refer to, or may be performed by, a data processing apparatus as described with reference to FIGS. 1, 3-5, 12, and 13. In an example, a user provides the document and the query to the data processing apparatus via a user interface displayed on a user device by the data processing apparatus as described with reference to FIG. 1.

At operation 910, the system computes an inter-sequence similarity metric based on the document and the query. In some cases, the operations of this step refer to, or may be performed by, a page identification component as described with reference to 3. In an example, the page identification component computes the inter-sequence similarity metric as described with reference to FIGS. 3 and 4.

At operation 915, the system identifies a relevant page of the document based on the inter-sequence similarity metric. In some cases, the operations of this step refer to, or may be performed by, a page identification component as described with reference to FIG. 3. In an example, the page identification component identifies the relevant page as described with reference to FIG. 3.

At operation 920, the system generates, using a language generation model, a response to the query based on the relevant page, where the response incudes the requested information about the document. In some cases, the operations of this step refer to, or may be performed by, a language generation model as described with reference to FIGS. 1 and 3-5. In an example, the language generation model generates the response as described with reference to FIGS. 3 and 5.

Accordingly, a method for data processing is described with reference to FIG. 9. One or more aspects of the method include receiving a document and a query requesting information about the document; computing an inter-sequence similarity metric based on the document and the query; identifying a relevant page of the document based on the inter-sequence similarity metric; and generating, using a language generation model, a response to the query based on the relevant page, wherein the response incudes the requested information about the document.

Some examples of the method further include generating a query embedding based on the query. Some examples further include generating a page embedding based on the relevant page. Some examples further include computing the inter-sequence similarity metric based on the query embedding and the page embedding.

Some examples of the method further include transforming the query embedding into a low-dimensional feature space to obtain a transformed query embedding. Some examples further include transforming the page embedding into the low-dimensional feature space to obtain a transformed page embedding, wherein the inter-sequence similarity metric is computed based on the transformed query embedding and the transformed page embedding.

Some examples of the method further include encoding the relevant page to obtain an image embedding, wherein the page embedding is based on the image embedding. Some examples of the method further include combining the image embedding with a text prompt to obtain a retrieval prompt, wherein the page embedding is based on the retrieval prompt. In some aspects, the language generation model comprises a first adaptation layer and a second adaptation layer trained separately from the first adaptation layer.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 10 shows an example of an algorithm 1000 for training a machine learning model according to aspects of the present disclosure. Referring to FIG. 10, according to some aspects, an inter-sequence similarity metric computed as described in Equation 1 is used in contrastive learning to facilitate ranked retrieval. In some embodiments, a training component of a data processing apparatus (such as the training component 1325 described with reference to FIG. 13) trains a first adaptation layer of a language generation model (such as the first adaptation layer 420 described with reference to FIG. 4) to maximize a late-interaction score (the inter-sequence similarity metric) between a query and a corresponding evidence image, considering the query and the corresponding evidence image as a positive pair. In some embodiments, the training component identifies a most similar, but unassociated, image within a batch of images to the query to form a negative pair. The loss function is defined as:

$$ℒ = log ( 1 + exp ( {s}_{LI} ( {E}_{q} , {E}_{v}^{-} ) - {S}_{LI} ( {E}_{q} , {E}_{v}^{+} ) ) ) \qquad ( 4 )$$

Referring to FIG. 4, the late-interaction score is maximized for the positive pair and minimized for the negative pair. The training component updates parameters of the first adaptation layer according to the loss function as described with reference to FIG. 11. In some embodiments, the training component updates parameters of a projection head (such as the projection head 425 described with reference to FIG. 4) according to the loss function as described with reference to FIG. 11. Algorithm 1000 summarizes the process of obtaining the loss function and updating parameters according to the loss function. In FIG. 10, “Col” refers to “contextualized late interaction”.

According to some aspects, the training component updates parameters of a second adaptation layer of the language generation model (e.g., the second adaptation layer 520 described with reference to FIG. 5) according to a loss function computed by comparing a response to a target response, where the response is generated by the language generation model using the second adaptation layer based on a training image and a training query. In some embodiments, the training component updates the parameters of the second adaptation layer according to the loss function as described with reference to FIG. 11.

FIG. 11 shows an example of a flow diagram depicting an algorithm as a step-by-step procedure 1100 for training a machine-learning model according to aspects of the present disclosure according to aspects of the present disclosure. In some embodiments, the procedure 1100 describes an operation of the training component 1325 described for configuring the machine learning model 1315 as described with reference to FIG. 13. The procedure 1100 provides one or more examples of generating training data, use of the training data to train a machine learning model, and use of the trained machine learning model to perform a task.

To begin in this example, a machine learning system collects training data (block 1102) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1104) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1106). Initialization of the machine learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine learning model (i.e., predictions) and target values (e.g., as expressed by the training data) to be used to train the machine learning model. Additionally, an optimization algorithm is selected (1112) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1118) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1120), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine learning model using the training data (block 1118) in this example.

If the stopping criterion is met (“yes” from decision block 1120), the trained machine learning model is then utilized to generate an output based on subsequent data (block 1122). The trained machine learning model, for instance, is trained to perform a task as described above and therefore once trained is configured to perform that task based on subsequent data received as an input and processed by the machine learning model.

### Data Processing Apparatus

FIG. 12 shows an example of a computing device 1200 according to aspects of the present disclosure. Computing device 1200 is an example of, or includes aspects of, the data processing apparatus described with reference to FIGS. 1, 3-5, and 13. In one aspect, computing device 1200 includes processor(s) 1205, memory subsystem 1210, communication interface 1215, I/O interface 1220, user interface component(s) 1225, and channel 1230. In some embodiments, computing device 1200 includes one or more processors 1205 that can execute instructions stored in memory subsystem 1210.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI.

FIG. 13 shows an example of a data processing apparatus 1300 according to aspects of the present disclosure. Data processing apparatus 1300 is an example of, or includes aspects of, the corresponding element described with reference to FIGS. 1, 3-5, and 12. In some embodiments, data processing apparatus 1300 includes processor unit 1305, memory unit 1310, machine learning model 1315, I/O module 1320, and training component 1325. Training component 1325 updates parameters of the machine learning model 1315 stored in memory unit 1310. In some examples, the training component 1325 is located outside the data processing apparatus 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing. According to some aspects, processor unit 1305 comprises one or more processors 1205 described with reference to FIG. 12.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state. According to some aspects, memory unit 1310 is an example of the memory subsystem 1210 described with reference to FIG. 12.

According to some aspects, data processing apparatus 1300 uses one or more processors of processor unit 1305 to execute instructions stored in memory unit 1310 to perform functions described herein. For example, the data processing apparatus 1300 may perform operations comprising receiving a document and a query requesting information about the document; identifying, using a language generation model, a relevant page of the document based on the query; and generating, using the language generation model, a response to the query based on the relevant page, wherein the response incudes the requested information about the document.

The memory unit 1310 may include a machine learning model 1315. According to some aspects, machine learning model 1315 comprises machine learning parameters stored in memory unit 1310. Machine learning model 1315 comprises one or more of the language generation model described with reference to FIGS. 1 and 3-5, the vision encoder described with reference to FIGS. 3-5, and the projection head described with reference to FIG. 4.

In some embodiments, the machine learning model 1315 is an artificial neural network (ANN) such as the transformer described with reference to FIG. 6. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the machine learning model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1325 may train the machine learning model 1315. For example, parameters of the machine learning model 1315 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 10-11). The goal of the training process may be to find optimal values for the parameters that allow the machine learning model 1315 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1315 can be used to make predictions on new, unseen data (i.e., during inference).

I/O module 1320 receives inputs from and transmits outputs of the data processing apparatus 1300 to other devices or users. For example, I/O module 1320 receives inputs for the machine learning model 1315 and transmits outputs of the machine learning model 1315. According to some aspects, I/O module 1320 is an example of the I/O interface 1220 described with reference to FIG. 12.

According to some aspects, training component 1325 comprises executable code (e.g., software) stored in memory unit 1310, firmware, one or more hardware circuits, or a combination thereof.

Accordingly, a system and an apparatus are described with reference to FIGS. 1-6 and 12-13. One or more aspects of the system and apparatus include a memory component and a processing device coupled to the memory component. The processing device is configured to perform operations including receiving a document and a query requesting information about the document; identifying, using a language generation model, a relevant page of the document based on the query; and generating, using the language generation model, a response to the query based on the relevant page, wherein the response incudes the requested information about the document.

In some aspects, the relevant page is identified using a first adaptation layer of the language generation model. In some aspects, the response is generated using a second adaptation layer of the language generation model. In some aspects, the language generation model includes a transformer. In some aspects, the system and/or the apparatus includes a retrieval component including a vision encoder, a large language model, and a projection head.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
receiving a document and a query requesting information about the document;
identifying, using a language generation model, a relevant page of the document based on the query; and
generating, using the language generation model, a response to the query based on the relevant page, wherein the response incudes the requested information about the document.

2. The method of claim 1, wherein:
the relevant page includes an image and the response to the query is based on the image.

3. The method of claim 1, wherein identifying the relevant page comprises:
generating a query embedding based on the query;
generating a page embedding based on the relevant page; and
computing a similarity score based on the query embedding and the page embedding, wherein the relevant page is identified based on the similarity score.

4. The method of claim 3, further comprising:
transforming the query embedding into a low-dimensional feature space to obtain a transformed query embedding; and
transforming the page embedding into the low-dimensional feature space to obtain a transformed page embedding, wherein the similarity score is computed based on the transformed query embedding and the transformed page embedding.

5. The method of claim 3, wherein:
the similarity score comprises an inter-sequence similarity metric.

6. The method of claim 3, further comprising:
encoding the relevant page to obtain an image embedding, wherein the page embedding is based on the image embedding.

7. The method of claim 6, further comprising:
combining the image embedding with a text prompt to obtain a retrieval prompt, wherein the page embedding is based on the retrieval prompt.

8. The method of claim 7, further comprising:
combining the image embedding with the query to obtain a query prompt, wherein the response is generated based on the query prompt.

9. The method of claim 1, further comprising:
identifying a plurality of relevant pages of the document, wherein the response is based on the plurality of relevant pages.

10. The method of claim 1, wherein:
the language generation model comprises a first adaptation layer and a second adaptation layer trained separately from the first adaptation layer.

11. A non-transitory computer readable medium storing code for data processing, the code comprising instructions that, when executed by at least one processor, cause the at least one processor to perform operations comprising:
receiving a document and a query requesting information about the document;
computing an inter-sequence similarity metric based on the document and the query;
identifying a relevant page of the document based on the inter-sequence similarity metric; and
generating, using a language generation model, a response to the query based on the relevant page, wherein the response incudes the requested information about the document.

12. The non-transitory computer readable medium of claim 11, wherein identifying the relevant page comprises:
generating a query embedding based on the query;
generating a page embedding based on the relevant page; and
computing the inter-sequence similarity metric based on the query embedding and the page embedding.

13. The non-transitory computer readable medium of claim 12, the code further comprising instructions that, when executed by the at least one processor, cause the at least one processor to perform operations comprising:
transforming the query embedding into a low-dimensional feature space to obtain a transformed query embedding; and
transforming the page embedding into the low-dimensional feature space to obtain a transformed page embedding, wherein the inter-sequence similarity metric is computed based on the transformed query embedding and the transformed page embedding.

14. The non-transitory computer readable medium of claim 11, the code further comprising instructions that, when executed by the at least one processor, cause the at least one processor to perform operations comprising:
encoding the relevant page to obtain an image embedding, wherein the page embedding is based on the image embedding.

15. The non-transitory computer readable medium of claim 14, the code further comprising instructions that, when executed by the at least one processor, cause the at least one processor to perform operations comprising:
combining the image embedding with a text prompt to obtain a retrieval prompt, wherein the page embedding is based on the retrieval prompt.

16. The non-transitory computer readable medium of claim 11, wherein:
the language generation model comprises a first adaptation layer and a second adaptation layer trained separately from the first adaptation layer.

17. A system comprising:
a memory component; and
a processing device coupled to the memory component, the processing device configured to perform operations comprising:
receiving a document and a query requesting information about the document;
identifying, using a language generation model, a relevant page of the document based on the query; and
generating, using the language generation model, a response to the query based on the relevant page, wherein the response incudes the requested information about the document.

18. The system of claim 17, wherein:
the relevant page is identified using a first adaptation layer of the language generation model; and
the response is generated using a second adaptation layer of the language generation model.

19. The system of claim 17, wherein:
the language generation model comprises a transformer.

20. The system of claim 17, wherein:
the system comprises a retrieval component including a vision encoder, a large language model, and a projection head.
